(19) United States
(12) Patent Application Publication
(10) Pub. No.: US 2013/0009860 A1
(43) Pub. Date: Jan. 10, 2013

(54) INFORMATION DISPLAY APPARATUS

(75) Inventor: Toshitada Kameda, Kamogawa City (JP)

(73) Assignee: Disease Management Strategies International Inc., Tokyo (JP)

(21) Appl. No.: 13/424,973

(22) Filed: Mar. 20, 2012

(30) Foreign Application Priority Data
Jul. 8, 2011 (JP) 2011-151688

(51) Int. Cl. G09G 5/00

(52) U.S. Cl. 345/156

(57) ABSTRACT

An information display apparatus includes: an outputting device capable of (i) displaying a first image in which data values corresponding to at least a first portion out of a plurality of data values included in one dataset of a plurality of datasets are indicated by characters and in which at least one portion of the data values can be changed and (ii) displaying a second image in which data values corresponding to at least a second portion out of the plurality of data values included in the one dataset are graphically indicated and in which at least one portion of the data values can be changed; and a controlling device for changing at least one portion of the data values included in the one dataset in accordance with a received change instruction if the instruction for one of the first image and second image is received by an inputting device.

### BACKGROUND OF THE INVENTION

1. Field of the Invention

The present invention relates to an information display apparatus used to assist users or the like. The present invention typically relates to a medical information display apparatus preferably used to assist users, such as doctors, in a medical information system.

2. Description of Related Art

This type of apparatus suggested is a system for checking whether or not clinical operations follow a predetermined protocol, for providing an outline of tasks that each of mutually different healthcare specialists such as doctors and nurses has to perform, and for aiding the healthcare specialists in making diagnostic and therapeutic determinations. Here, in particular, it is disclosed that results of physical examination can be inputted and displayed on a Schema diagram (refer to Japanese Patent Application Laid Open No. 2009-514087).

Alternatively, for example, in another apparatus suggested, if one site included in a schematic view showing a human body displayed on a screen is selected, items for selecting disease names corresponding to the selected one site are displayed, and if one disease name is selected from the displayed items for selecting the disease names, detailed treatment method data corresponding to the selected one disease name is obtained, and the obtained treatment method data is displayed as a treatment information window (refer to Japanese Patent Application Laid Open No. 2003-271672).

However, in the aforementioned related art, it is hard to provide a user with the data in a plurality of aspects. Then, for example, there is such a technical problem that different apparatuses (or different software) need to be used between a case where character data such as a numerical number is displayed on a screen to understand the details and a case where image data is displayed on the screen such that a patient can understand the content intuitively when the user explain to the patient. In addition, it is not easy to synchronize the data between the different apparatuses (or different software), which is also technically problematic.

### SUMMARY OF THE INVENTION

It is therefore an object of the present invention to provide an information display apparatus capable of providing the user with the data in a plurality of aspects and capable of updating the data in any of the aspects.

The above object of the present invention can be achieved by an information display apparatus provided with: a display part; an inputting device capable of receiving a user's input; a storing device for storing therein a plurality of datasets, each including (i) a plurality of data items and (ii) a plurality of data values each corresponding to respective one of the plurality of data items; an outputting device capable of (i) outputting to the display part a first image in which data values corresponding to at least a first portion out of the plurality of data values included in one dataset of the stored plurality of datasets are indicated by characters and in which at least one portion of the data values indicated by the characters can be changed and (ii) outputting to the display part a second image in which data values corresponding to at least a second portion out of the plurality of data values included in the one dataset are graphically indicated and in which at least one portion of the data values graphically indicated can be changed; and a controlling device for controlling the outputting device when the user's input is received by the inputting device, so as to output to the display part at least one of the first image and the second image in accordance with the received input, the controlling device changing at least one portion of the data values included in the one dataset in accordance with a received first change instruction if the first change instruction for the at least one image outputted is received by the inputting device.

According to the information display apparatus of the present invention, the information display apparatus is provided with: the display part such as, for example, a liquid crystal display and an electroluminescence (EL) display; and the inputting device such as, for example, a keyboard, a mouse, and a graphics tablet, capable of receiving the user's input. Incidentally, the inputting device may be a touch panel configured as a unified body with the display part.

The storing device such as, for example, a flash memory and a hard disk stores therein the plurality of datasets. Each of the plurality of datasets includes (i) the plurality of data items and (ii) the plurality of data values each corresponding to respective one of the plurality of data items. Here, the “data value” is not limited to a numerical number (i.e. numeric attribute) but may be letters (i.e. character attribute: character).

The outputting device which is provided with, for example, a memory, a processor, and the like can output to the display part the first image in which the data values corresponding to at least the first portion out of the plurality of data values included in one dataset of the stored plurality of datasets are indicated by characters and in which at least one portion of the data values indicated by the characters can be changed.

The outputting device can further output to the display part the second image in which the data values corresponding to at least the second portion out of the plurality of data values included in the one dataset are graphically indicated and in which at least one portion of the data values graphically indicated can be changed.

The “first portion” and the “second portion” may be different from, or be equal to, or partially overlap each other. Alternatively, one of the first portion and the second portion may be included in the other.

The expression “data values . . . are graphically indicated” means, for example, that the data values are indicated by using drawings displayed on a screen, such as drawings corresponding to or related to the data items, icons for symbolizing the data items and the data values, and buttons for indicating the data items and the data values, or that the data values are indicated by a combination of the drawings and characters. Here, the “drawing” is not limited to a geometric shape (i.e. graphic) but conceptually includes a graphic, a diagram, a painting, a map, and the like. The drawing may be referred to as a design or a drawing pattern. Typically, it is a two-dimensional image but may be a three-dimensional image.

The expression “can be changed” means that the data values included in the one dataset can be changed without separately through a management screen or the like, by inputting characters, numerical numbers, etc. in an input box included in the image, or by selecting options, icons, or the like to change the data values included in the image or to input data values that are not inputted, and thus to change either the first image or the second image.

The controlling device which is provided with, for example, a memory, a processor, and the like controls the outputting device when the user's input is received by the inputting device, so as to output to the display part at least one of the first image and the second image in accordance with the received input.

If both the “first image” and the “second image” are displayed on the display part, the details of each of the “first image” and the “second image” may not be displayed all the time. Specifically, for example, the details of one of the “first image” and the “second image” may be displayed on the display part, and the other of the “first image” and the “second image” may be displayed in a form of icon, tab, or the like.

The controlling device changes at least one portion of the data values included in the one dataset in accordance with the received first change instruction if the first change instruction for the at least one image outputted on the display part out of the first image and the second image is received by the inputting device.

The “change instruction” is specifically, for example, input of characters into the input box, selection of options, or the like regarding the first image, and it is designation, change, or the like of coordinates or a range on the displayed drawings regarding the second image.

As a result, according to the information display apparatus of the present invention, it is possible to provide the user with the data in the plurality of aspects and to change at least one portion of the data value included in the one dataset from any of the first image and the second image.

In one aspect of the information display apparatus of the present invention, when the first image and the second image are outputted to the display part, if a second change instruction for one of the first image and the second image outputted is received by the inputting device, the controlling device controls the outputting device to change at least one portion of the data values included in the one dataset in accordance with the received second change instruction and to update the other of the first image and the second image outputted, on the basis of the changed one dataset.

According to this aspect, when both the first image and the second image are displayed on the display part, the change given to one of the first image and the second image can be appropriately reflected in the other of the first image and the second image, which is extremely useful in practice.

In another aspect of the information display apparatus of the present invention, each of the plurality of datasets includes items associated with one or a plurality of medical practices included in a medical care process associated with a corresponding patient's disease, as at least one portion of the plurality of data items.

According to this aspect, the information display apparatus can be used as a medical care assistance tool for assisting medical care in a medical institution.

The “corresponding patient” means a patient corresponding to each of the plurality of datasets. In other words, it means that one dataset of the plurality of datasets corresponds to one patient.

In this case, the storing device may further store therein a plurality of practice guidelines corresponding to at least one portion of the one or the plurality of medical practices, and the outputting device can output to the display part a guideline corresponding to one medical practice out of the one or the plurality of medical practices, from the stored plurality of practice guidelines.

By virtue of such a configuration, a doctor or the like as the user of the information display apparatus can relatively easily refer to the practice guidelines, which is extremely useful in practice.

The “practice guideline” is a guideline in which information about grounds for the medical care and its procedure, such as disease prevention, diagnosis, treatment, and prognostic prediction, is compiled by specialists in an easy-to-understand manner in order to aid appropriate diagnosis and treatment on medical site.

In this aspect, the information display apparatus may be further provided with a medical care process generating device for generating medical care process information which indicates the medical care process on the basis of at least one portion of the stored plurality of practice guidelines.

By virtue of such a configuration, information associated with the standard medical care process can be provided for the doctor or the like as the user, relatively easily. As a result, the doctor or the like can adopt an appropriate medical practice, and thus, the quality of medical care can be improved.

In this case, the information display apparatus may be further provided with a specifying device for specifying an evaluation indicator associated with the one medical practice, at least on the basis of data values included in the one dataset and corresponding to one medical practice out of the one or the plurality of medical practices.

By virtue of such a configuration, the doctor or the like as the user can obtain an evaluation for the medical practice provided for a patient while providing medical care for the patient. Thus, the doctor or the like can judge the effect of the medical practice, relatively easily, which is extremely useful in practice.

The term “specify” of the present invention is not limited to directly specifying the evaluation indicator but conceptually includes calculating or deriving (i.e. indirectly specifying) the evaluation indicator on the basis of an algorithm and a formula for computation set in advance from some physical quantity or parameter or the like.

The “evaluation indicator” is specified (i) for example, in accordance with the content of ideal implementation determined in advance and the content of actual implementation included in the one dataset (i.e. the data values corresponding to the one medical practice), or (ii) for example, on the basis of the existing indicator such as a quality indicator (QI) and a statistical indicator, or (iii) for example, in accordance with the data values or the like included in each of the plurality of datasets. The “evaluation indicator” includes, for example, an indicator associated with “state recognition”, an indicator associated with “planning”, an indicator associated with “outcome (result)”, and the like.

In another aspect of the information display apparatus of the present invention, the information display apparatus is connected to a server apparatus through a network, and the information display apparatus is further provided with a communicating device for transmitting at least one portion of the plurality of data values included in each of the plurality of datasets stored in said storing device with the corresponding data items, to the server apparatus through the network.

According to this aspect, it is possible to integrate the data collected by each of a plurality of information display apparatuses and to prepare a relatively large database. As a result, for example, relatively accurate statistical data or the like can be provided for the user. Alternatively, for example, on the basis of the data accumulated in the server apparatus, a new standard or the like can be prepared.

The expression “at least one portion of the plurality of data values” means data values other than the data values that can identify the individual, out of the plurality of data values, or the like. By virtue of such a configuration, it is possible to collect the data inputted to the information display apparatus while appropriately protecting the user's privacy.

The nature, utility, and further features of this invention will be more clearly apparent from the following detailed description with reference to preferred embodiment of the invention when read in conjunction with the accompanying drawings briefly described below.

### BRIEF DESCRIPTION OF THE DRAWINGS

FIG. 1 is a block diagram showing the configuration of an information display apparatus in an embodiment of the present invention;

FIG. 2 is a view showing one example of a dataset in the embodiment of the present invention;

FIG. 3 is a view showing one example of a descriptive image in the embodiment of the present invention;

FIG. 4 is a view showing one example of a graphic image in the embodiment of the present invention;

FIG. 5A to FIG. 5C are views showing one example of each of the descriptive image and the graphic image in updating data;

FIG. 6 is a flowchart showing a display process in the embodiment of the present invention;

FIG. 7 is a view showing one example of a screen displayed on a display part of the information display apparatus in the embodiment of the present invention;

FIG. 8A to FIG. 8C are views showing another example of each of the descriptive image and the graphic image in updating the data;

FIG. 9A and FIG. 9B are views showing one example of graphic images associated with mammary MRI; and

FIG. 10A is a view showing one example of a graphic image associated with a preoperative therapy, and FIG. 10B is a view showing one example of an image showing a practice guideline.

### DETAILED DESCRIPTION OF THE PREFERRED EMBODIMENT

Hereinafter, the information display apparatus in the embodiment of the present invention will be explained with reference to the drawings. In the embodiment, a case where the information display apparatus of the present invention is applied to an information display apparatus for assisting doctors or the like in a medical institution will be exemplified.

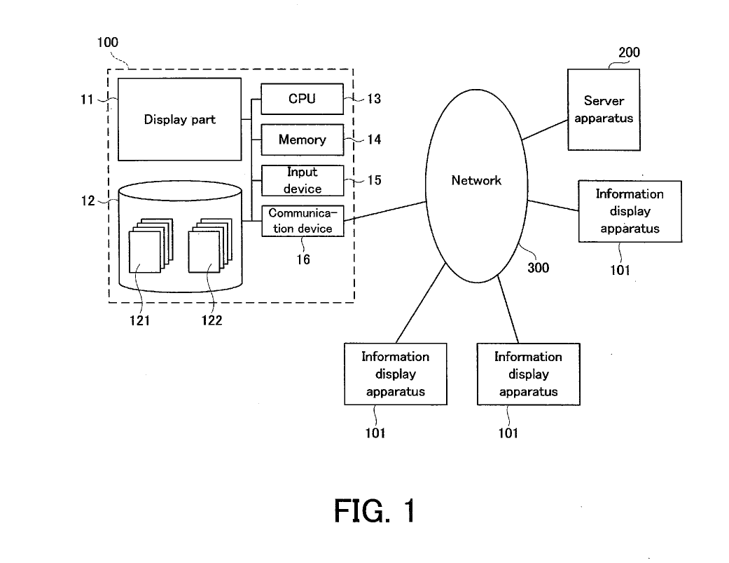

Firstly, the configuration of the information display apparatus in the embodiment will be explained with reference to FIG. 1. FIG. 1 is a block diagram showing the configuration of the information display apparatus in the embodiment.

In FIG. 1, an information display apparatus 100 is provided with a display part 11, a storing device 12, a central processing unit (CPU) 13, a memory 14, an input device 15, and a communication device 16.

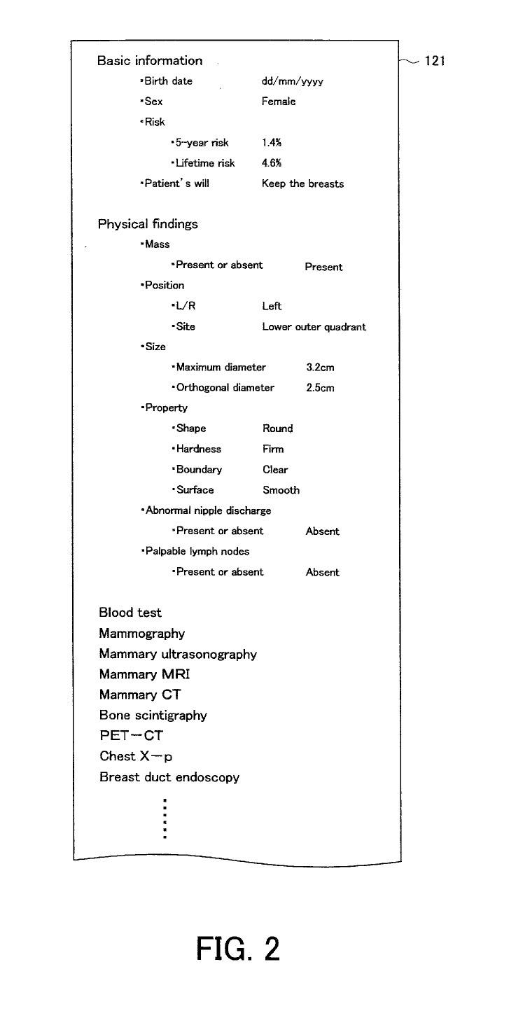

The storing device 12 stores therein a plurality of datasets 121 and a plurality of practice guidelines 122. Each of the plurality of datasets 121 includes, for example, as shown in FIG. 2, a plurality of data items (e.g. Birth date, 5-year risk, Site, Shape, etc.) and a plurality of data values each corresponding to respective one of the plurality of data items (e.g. “dd/mm/yyyy (day/month/year)”, “1.4%”, “Lower outer quadrant”, “Round”, etc.).

FIG. 2 shows one example of the dataset in the embodiment. The dataset 121 shown in FIG. 2 is one example of a dataset associated with a breast cancer patient. In the dataset 121, for example, “Physical findings”, “Blood test”, “Mammography”, “Mammary ultrasonography”, “Mammary MRI”, etc. are one example of medical practices included in a medical care process associated with breast cancer. Moreover, in the dataset 121, for example, “L/R”, “Site”, “Maximum diameter”, “Shape”, etc. are one example of items associated with the medical practices.

Each of the plurality of practice guidelines 122 stored in the storing device 12 is associated with at least one portion of the medical practices.

The communication device 16 is connected to a server apparatus 200 through a network 300 such as, for example, the Internet and a local area network (LAN). The communication device 16 transmits at least one portion of the plurality of data values included in each of the plurality of datasets 121 stored in the storing device 12, with information indicating the corresponding data items, to the server apparatus 200 through the network 300. Incidentally, the data received and transmitted between the information display apparatus 100 and the server apparatus 200 is encrypted in a predetermined encryption method.

Here, in particular, if the information display apparatus 100 can be configured to transmit to the server apparatus 200, for example, data values other than information capable of identifying the individual (i.e. personal information), such as a name, a birth date, and an address, out of the data values included in each of the plurality of datasets 121, then, it is possible to preferably accumulate case data associated with diseases while protecting the personal information about patients.

As shown in FIG. 1, to the server apparatus 200, not only the information display apparatus 100 but also a plurality of information display apparatuses 101 are connected through the network 300. Thus, the server apparatus 200 accumulates therein, for example, the case data transmitted not only from the information display apparatus 100 but also from each of the plurality of information display apparatuses 101. Incidentally, the configuration of the information display apparatuses 101 is the same as that of the information display apparatus 100, and thus, the explanation thereof will be omitted.

The server apparatus 200 may store therein a plurality of practice guidelines. In this case, the information display apparatus 100 may update at least one portion of the plurality of practice guidelines 122 stored in the storing device 12, on the basis of at least one portion of the plurality of practice guidelines stored in the server apparatus 200. Alternatively, the information display apparatus 100 may obtain a new practice guideline from the server apparatus 200 through the network 300. Alternatively, the information display apparatus 100 may store no practice guidelines in the storing device 12 but may refer to at least one portion of the plurality of practice guidelines stored in the server apparatus 200.

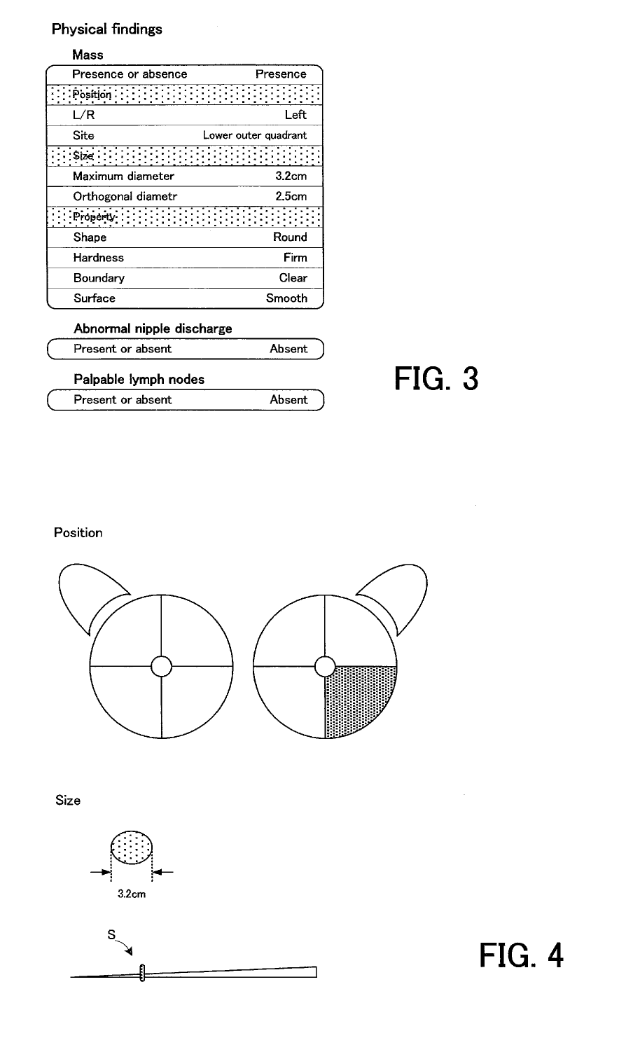

The CPU 13 can output to the display part 11 a descriptive image (refer to FIG. 3) in which data values corresponding to at least a first portion out of the plurality of data values included in one dataset of the plurality of datasets 121 are indicated by characters and in which at least one portion of the data values indicated by the characters can be changed.

The CPU 13 can further output to the display part 11 a graphic image (refer to FIG. 4) in which data values corresponding to at least a second portion out of the plurality of data values included in the one dataset described above are graphically indicated and in which at least one portion of the data values graphically indicated can be changed.

Then, when a user's input is received by the input device 15, the CPU 13 outputs to the display part 11 at least one of the descriptive image and the graphic image in accordance with the received input.

FIG. 3 shows one example of the descriptive image in the embodiment. FIG. 4 shows one example of the graphic image in the embodiment. Incidentally, the drawing in the upper part of FIG. 4 (i.e. drawing associated with the “Position”) is one example of a schematic view showing breasts and axillae. The drawing in the lower part of FIG. 4 (i.e. drawing associated with the “Size”) is one example of a schematic view showing a mass. A hatched portion in the drawing in the upper part of FIG. 4 corresponds to the position of the mass in FIG. 3 (i.e. the lower outer quadrant of a left breast).

The graphic image as shown in FIG. 4 can be used not only to schematize the data items and the data values included in the dataset 121 and to be provided for a user, but also to input or change the data values which are the basis for the graphic image. Specifically, for example, at one position on the drawing in the upper part of FIG. 4, the user clicks a mouse as one example of the input device 15, thereby inputting or changing the hatched portion (i.e. the position of the mass). Moreover, the user changes the position of a knob or lever of a slider S in the drawing in the lower part of FIG. 4, thereby changing the size of the mass.

Then, the change instruction for the graphic image is also reflected in the corresponding dataset 121 and the corresponding descriptive image. In other words, if the change instruction for the graphic image is received by the input device 15, the CPU 13 can change at least one portion of the data values included in the datasets 121 in accordance with the received change instruction and update the descriptive image displayed on the display part 11 on the basis of the changed dataset 121, or generate a new descriptive image and then output it to the display part 11.

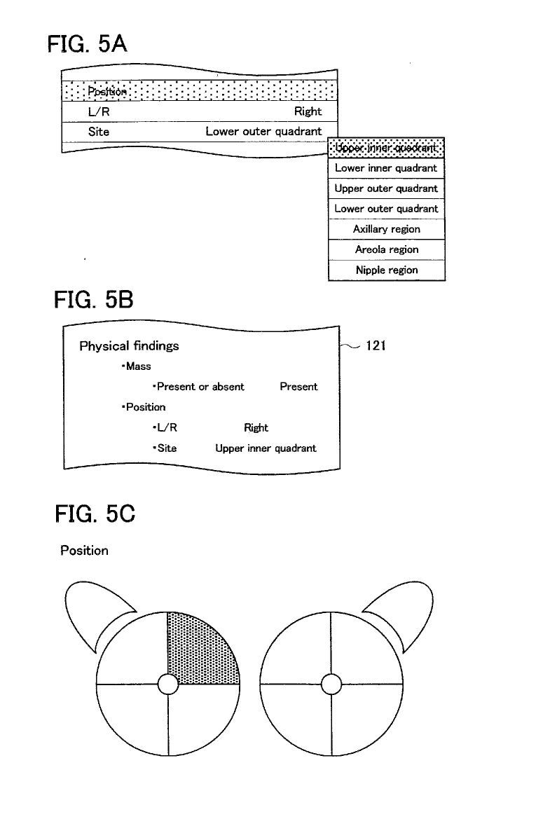

In the same manner, a change instruction for the descriptive image is also reflected in the corresponding dataset 121 and the corresponding graphic image. Specifically, for example, when the descriptive image shown in FIG. 3 and the graphic image shown in FIG. 4 are displayed on the display part 11, as shown in FIG. 5A, if a change instruction indicating a change in the position of the mass for the displayed descriptive image is received by the input device 15 (here, it is assumed that the position is changed from “Left” to “Right” and from “Lower outer quadrant” to “Upper inner quadrant”), the CPU 13 changes the data values corresponding to the data items (here, “L/R” and “Site”) included in the corresponding dataset 121 (refer to FIG. 5B). Then, the CPU 13 updates the graphic image as shown in FIG. 5C, on the basis of the changed dataset 121. Incidentally, the process of updating the dataset 121 and the process of updating the graphic image may be performed in parallel.

FIG. 5A to FIG. 5C show one example of each of the descriptive image and the graphic image in updating the data. In an example shown in FIG. 5A, the site is selected from a pull-down menu; however, the user may also directly input it.

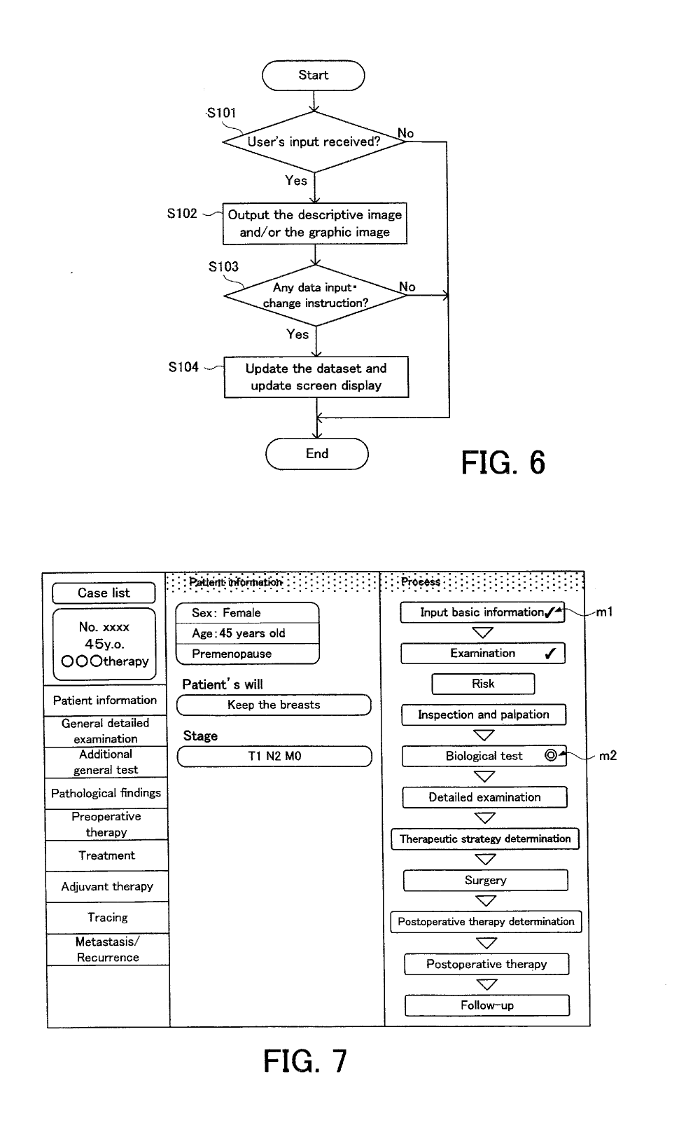

Next, a display process performed by the CPU 13 on the information display apparatus 100 as configured above will be explained with reference to a flowchart in FIG. 6.

In FIG. 6, firstly, the CPU 13 judges whether or not the user's input is received by the input device 15 (step S101). If it is judged that the user's input is not received by the input device 15 (the step S101: No), the CPU 13 ends the process once.

If it is judged that the user's input is received by the input device 15 (the step S101: Yes), the CPU 13 outputs to the display part 11 at least one of the descriptive image and the graphic image on the basis of the corresponding dataset 121 in accordance with the received input (step S102).

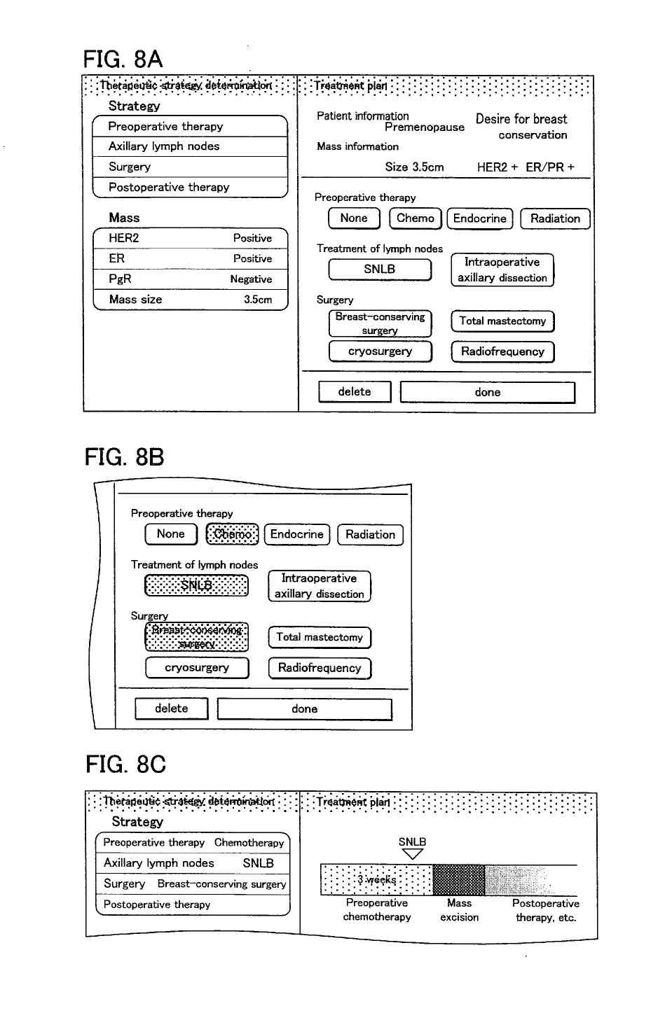

Specifically, for example, when a screen as shown in FIG. 7 is displayed on the display part 11, for example, if the user presses (i.e. clicks) a button indicating “Therapeutic strategy determination”, the CPU 13 outputs the descriptive image and the graphic image such that, for example, a screen as shown in FIG. 8A is displayed on the display part 11.

FIG. 7 shows one example of the screen displayed on the display part of the information display apparatus in the embodiment. In FIG. 7, the left part shows one example of a menu bar, the middle part (i.e. “Patient information”) shows one example of the descriptive image, and the right part (i.e. “Process”) shows one example of the graphic image.

The “process” shown in FIG. 7 is an image graphically showing a medical care process associated with a patient's disease (here, breast cancer). Such an image is generated on the basis of medical care process information, which indicates the medical care process and which is generated on the basis of at least one portion of the plurality of practice guidelines 122 stored in the storing device 12, or on the basis of at least one portion of the plurality of practice guidelines stored in the server apparatus 200, by the CPU 13.

Each of marks m1 and m2 in FIG. 7 indicates a progress situation. Specifically, the mark m1 indicates an ended process, and the mark m2 indicates a current process. Incidentally, in FIG. 7, for example, “Risk” and “Inspection and palpation” indicate subordinate (i.e. detailed) items included in the “medical care” process. Such subordinate items exist not only in the “medical care” process but also in another process; however, its illustration is omitted here.

FIG. 8A shows one example of each of the descriptive image (refer to “Therapeutic strategy determination” in the left part of FIG. 8A) and the graphic image (refer to “Treatment plan” in the right part of FIG. 8A) associated with a process of “Therapeutic strategy determination”. Here, in particular, the data value corresponding to each item (e.g. “Preoperative therapy”, etc.) in “Strategy” in the left part of FIG. 8A is undecided (i.e. not inputted). In the same manner, options (e.g. “None”, etc.) in each of “Preoperative therapy”, “Treatment of lymph nodes”, and “Surgery” are also not selected.

Back in FIG. 6 again, after the process operation in the step S102, the CPU 13 judges whether or not an input instruction or change instruction for one of the descriptive image and the graphic image from the user is received by the input device 15 (step S103). If it is judged that the input instruction or change instruction is not received by the input device 15 (the step S103: No), the CPU 13 ends the process once.

If it is judged that the input instruction or change instruction is received by the input device 15 (the step S103: Yes), the CPU 13 changes at least one portion of the data values included in the corresponding dataset 121 in accordance with the received input instruction or change instruction and updates the other of the descriptive image and the graphic image on the basis of the changed dataset 121 (step S104).

Specifically, for example, as shown in FIG. 8B, if the user selects “Chemo”, “SNLB”, and “Breast-conserving surgery” and presses a “done” button (i.e. if the input instruction for the graphic image is received), the CPU 13 changes the data values included in the corresponding dataset 121 (here, the data values corresponding to the data items of “Preoperative therapy”, “Treatment of (axillary) lymph nodes” and “Surgery”). The CPU 13 further updates the descriptive image (refer to the left part of FIG. 8C) on the basis of the changed dataset 121. As a result, as shown in the left part of FIG. 8C, the respective data values corresponding to the items of “Preoperative therapy”, “Treatment of (axillary) lymph nodes” and “Surgery” are displayed.

The CPU 13 may further update the graphic image on the basis of the changed dataset 121, or output a new graphic image, as shown in the right part of FIG. 8C. Here, for example, a period for performing a preoperative chemotherapy (i.e. 3 weeks) and timing for performing SNLB (sentinel lymph node biopsy) are graphically shown.

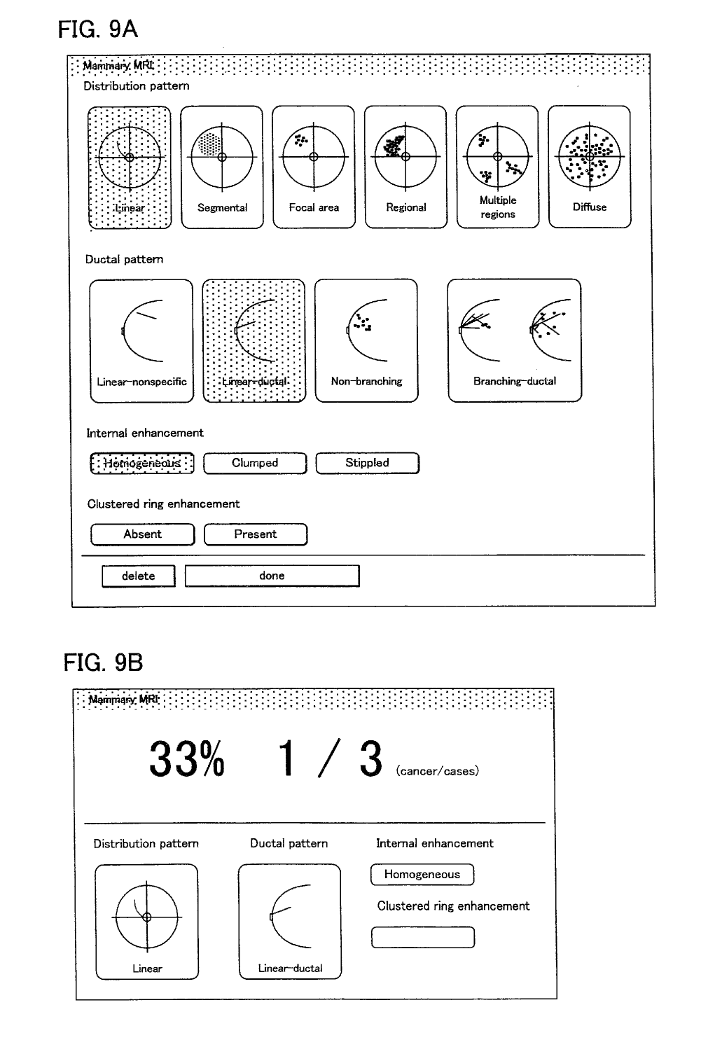

Next, with reference to FIG. 9A and FIG. 9B, an explanation will be given on a case where, for example, on the screen shown in FIG. 7, “Detailed examination” in the menu bar is selected by the user and then “Mammary MRI” (not illustrated) which is a subordinate item of the “Detailed examination” is selected. FIG. 9A and FIG. 9B show one example of graphic images associated with the mammary MRI.

If “Mammary MRI” is selected by the user, the CPU 13 outputs to the display part 11 the graphic image as shown in FIG. 9A, on the basis of the corresponding dataset 121 stored in the storing device 12. Incidentally, it is assumed that icons and buttons, etc. shown in FIG. 9A are not selected at the beginning when the graphic image is outputted to the display part 11.

Then, if the icons and the button included in the graphic image are selected by the user (here, if “Linear”, “Linear-ductal” and “Homogeneous” are selected and a “done” button is pressed), the CPU 13 changes at least one portion of the data values included in the corresponding dataset 121.

The CPU 13 specifies an evaluation indicator associated with the mammary MRI, on the basis of data values corresponding to the mammary MRI out of the data values included in the changed dataset 121, the case data accumulated in the server apparatus 200, and the like. Then, the CPU 13 outputs the specified evaluation indicator as one portion of the graphic image (refer to FIG. 9B).

Here, the CPU 13 specifies probability of the breast cancer, as the evaluation indicator. Specifically, for example, the CPU 13 searches for case data having the data values corresponding to the mammary MRI of “Linear”, “Linear-ductal” and “Homogeneous” from the case data accumulated in the server apparatus 200. The CPU 13 specifies the probability of the breast cancer (here, 33%) from the searched case data (here, 33 cases).

By virtue of such a configuration, it is possible to suppress variations in the users' judgment (here, doctors, etc.) or the like. This makes it possible to reduce the possibility that the quality of medical care varies among individual doctors or medical institutions.

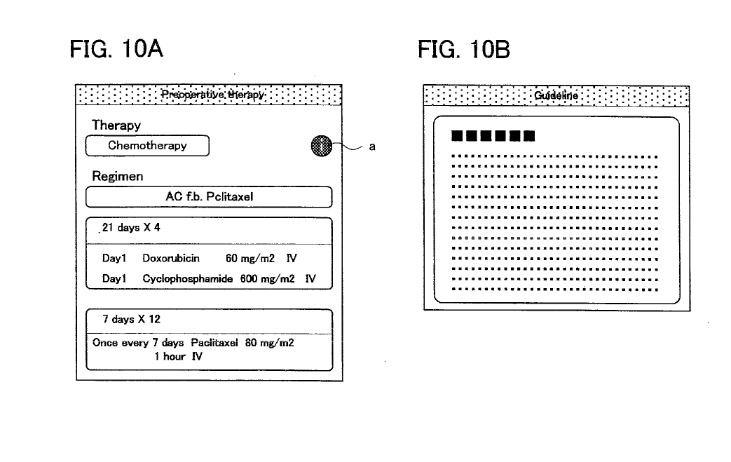

Next, with reference to FIG. 10A and FIG. 10B, an explanation will be given on a case where, for example, on the screen shown in FIG. 7, “Preoperative therapy” in the menu bar is selected by the user. FIG. 10A shows one example of a graphic image associated with the preoperative therapy, and FIG. 10B is a view showing one example of an image showing a practice guideline.

If “Preoperative therapy” is selected by the user, the CPU 13 displays on the display part lithe graphic image as shown in FIG. 10A, on the basis of the corresponding dataset 121 stored in the storing device 12.

Then, if an icon a included in the graphic image is pressed by the user, the CPU 13 outputs to the display part 11 at least one portion of the content of the practice guideline corresponding to chemotherapy, out of the plurality of practice guidelines stored in the storing device 12 or the plurality of practice guidelines stored in the server apparatus 200 (refer to FIG. 10B).

By virtue of such a configuration, the user can relatively easily refer to the practice guideline corresponding to one medical practice, which is extremely useful in practice.

The “CPU 13” in the embodiment is one example of the “outputting device”, the “controlling device”, the “medical care process generating device”, and the “specifying device”. The “storing device 12”, the “descriptive image”, and the “graphic image” in the embodiment are one example of the “storing device”, the “first image”, and the “second image”, respectively.

The information display apparatus of the present invention can be applied not only to an information display apparatus for assisting doctors and the like in a medical institution, but also to, for example, a management tool for one department of a company, a training management tool for athletes or the like, a management tool for a learning program, and the like.

The invention may be embodied in other specific forms without departing from the spirit or essential characteristics thereof. The present embodiment is therefore to be regarded in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2011-151688 on Jul. 8, 2011 including the specification, claims, drawings and summary is incorporated herein by reference in its entirety.

1. An information display apparatus comprising:
a display part;
an inputting device capable of receiving a user's input;
a storing device for storing therein a plurality of datasets, each including (i) a plurality of data items and (ii) a plurality of data values each corresponding to respective one of the plurality of data items;
an outputting device capable of (i) outputting to said display part a first image in which data values corresponding to at least a first portion out of the plurality of data values included in one dataset of the stored plurality of datasets are indicated by characters and in which at least one portion of the data values indicated by the characters can be changed and (ii) outputting to said display part a second image in which data values corresponding to at least a second portion out of the plurality of data values included in the one dataset are graphically indicated and in which at least one portion of the data values graphically indicated can be changed; and
a controlling device for controlling said outputting device when the user's input is received by said inputting device, so as to output to said display part at least one of the first image and the second image in accordance with the received input,
said controlling device changing at least one portion of the data values included in the one dataset in accordance with a received first change instruction if the first change instruction for the at least one image outputted is received by said inputting device.

2. The information display apparatus according to claim 1, wherein when the first image and the second image are outputted to said display part, if a second change instruction for one of the first image and the second image outputted is received by said inputting device, said controlling device controls said outputting device to change at least one portion of the data values included in the one dataset in accordance with the received second change instruction and to update the other of the first image and the second image outputted, on the basis of the changed one dataset.

3. The information display apparatus according to claim 1, wherein each of the plurality of datasets includes items associated with one or a plurality of medical practices included in a medical care process associated with a corresponding patient's disease, as at least one portion of the plurality of data items.

4. The information display apparatus according to claim 3, wherein
said storing device further stores therein a plurality of practice guidelines corresponding to at least one portion of the one or the plurality of medical practices, and
said outputting device can output to said display part a guideline corresponding to one medical practice out of the one or the plurality of medical practices, from the stored plurality of practice guidelines.

5. The information display apparatus according to claim 4, further comprising a medical care process generating device for generating medical care process information which indicates the medical care process on the basis of at least one portion of the stored plurality of practice guidelines.

6. The information display apparatus according to claim 3, further comprising a specifying device for specifying an evaluation indicator associated with the one medical practice, at least on the basis of data values included in the one dataset and corresponding to one medical practice out of the one or the plurality of medical practices.

7. The information display apparatus according to claim 1, wherein
said information display apparatus is connected to a server apparatus through a network, and
said information display apparatus further comprises a communicating device for transmitting at least one portion of the plurality of data values included in each of the plurality of datasets stored in said storing device with the corresponding data items, to the server apparatus through the network.

8. The information display apparatus according to claim 1,
further comprising a communicating device for communicating with a server apparatus which is placed on a network, and which accumulates a plurality of case data associated with breast cancer,
the plurality of data items including an item of mammary MRI,
said controlling device controlling said outputting device when display-instruction. for the item of mammary MRI is received by said inputting device, so as to output to said display part the second image which includes a plurality of icons each of which indicates a unique imaging pattern in accordance with the received display-instruction,
said information display apparatus further comprising a specifying device for searching, if data value corresponding to the item of mammary MRI is inputted by selecting one or more icons from the plurality of icons included the outputted second image, one or more case data, data value corresponding to the item of mammary MRI of which is equal to the inputted data value from the plurality of case data accumulated in said server apparatus through the network, and for specifying probability of breast cancer on the basis of the searched case data.
